(19) United States
(12) Patent Application Publication
(10) Pub. No.: US 2025/0250122 A1
(43) Pub. Date: Aug. 7, 2025

(54) CONVEYING DEVICE

(71) Applicant: Honda Motor Co., Ltd., Tokyo (JP)

(72) Inventors: Yuichi HIRATA, Tokyo (JP); Tsubasa NAKASHIMA, Tokyo (JP); Kyohei MATSUSHITA, Tokyo (JP)

(73) Assignee: Honda Motor Co., Ltd., Tokyo (JP)

(21) Appl. No.: 18/961,451

(22) Filed: Nov. 27, 2024

(30) Foreign Application Priority Data
Feb. 1, 2024 (CN) 202410141406.5

(51) Int. Cl. B65G 47/28

(52) U.S. Cl. CPC B65G 47/28

(57) ABSTRACT

A conveying device is provided. The conveying device includes: a suction roller, configured to generate negative pressure to adsorb the conveyed object; and a cap component, disposed between the suction roller and the conveyed object. The cap component has a platform portion, the platform portion faces the conveyed object, the platform portion includes a first platform portion and a second platform portion, the first platform portion and the second platform portion are respectively disposed on a downstream side and an upstream side of the suction roller in a conveying direction, the first platform portion and the second platform portion are separated from each other, and an open portion exposing the suction roller is disposed in a region where the first platform portion and the second platform portion are separated in the conveying direction.

### CROSS-REFERENCE TO RELATED APPLICATION

This application claims the priority benefit of China application serial no. 202410141406.5, filed on Feb. 1, 2024. The entirety of the above-mentioned patent application is hereby incorporated by reference herein and made a part of this specification.

### BACKGROUND

### Technical Field

The disclosure relates to a conveying device.

### Description of Related Art

In recent years, in order to ensure more people have access to affordable, reliable, sustainable, and advanced energy, technologies for improving energy efficiency that contribute to energy efficiency have been researched and developed, which involves many production processes, manufacturing procedures, and equipment that help save energy.

For example, Patent Literature 1 (Japanese Utility Model Publication No. 02-061859) discloses a suction roller that sucks an adsorbate through a roller component having multiple through holes and winds the adsorbate onto the surface of the roller component. The technology of using a suction roller having such a structure as a conveying device for conveying an adsorbate to a next procedure during a manufacturing process is well known. However, in the case of Patent Literature 1, a conveyed object is attracted by the adsorption force of the roller component and is tightly attached, thereby forming a shape along a curved surface of the roller component. Therefore, in the case where it is intended to adsorb and hold the conveyed object (for example, a steel plate used in an automobile) through negative pressure during a conveying process without causing the conveyed object to bend, the conveying device is not applicable. Furthermore, when the conveyed object is adsorbed and held through negative pressure during the conveying process, if the conveyed object is not bent due to its own characteristics, the conveyed object and the roller component are only in linear contact, which may reduce the adsorption force and easily cause deviation during the conveying process. Therefore, there is still room for improvement in how to properly convey the conveyed object during the manufacturing process.

The disclosure aims to achieve proper conveyance of the conveyed object, while contributing to energy efficiency.

### SUMMARY

The disclosure provides a conveying device. The conveying device includes: a suction roller, configured to generate negative pressure to adsorb a conveyed object; and a cap component, disposed between the suction roller and the conveyed object, wherein the cap component has a platform portion, the platform portion faces the conveyed object, the platform portion includes a first platform portion and a second platform portion, the first platform portion and the second platform portion are respectively disposed on a downstream side and an upstream side of the suction roller in a conveying direction, the first platform portion and the second platform portion are separated from each other, and an open portion exposing the suction roller is disposed in a region where the first platform portion and the second platform portion are separated in the conveying direction.

### BRIEF DESCRIPTION OF THE DRAWINGS

FIG. 1 is a schematic structural diagram of a conveying device according to an embodiment of the disclosure.

FIG. 2A is a schematic partially enlarged diagram of a conveying unit shown in FIG. 1.

FIG. 2B is a schematic diagram of the conveying unit shown in FIG. 1 after a cap component is removed.

FIG. 3 is a schematic cross-sectional structural diagram of the conveying unit of FIG. 2A along a section line A-A.

FIG. 4 is a schematic cross-sectional structural diagram of the conveying unit of FIG. 2A along a section line B-B.

FIG. 5A is a schematic partially enlarged diagram of another conveying unit shown in FIG. 1.

FIG. 5B is a schematic cross-sectional structural diagram of the conveying unit of FIG. 5A along a section line C-C.

### DESCRIPTION OF THE EMBODIMENTS

The disclosure provides a conveying device, which uses a suction roller and can hold and convey a conveyed object without bending the conveyed object while having sufficient adsorption force.

The disclosure provides a conveying device. The conveying device includes: a suction roller, configured to generate negative pressure to adsorb a conveyed object; and a cap component, disposed between the suction roller and the conveyed object, wherein the cap component has a platform portion, the platform portion faces the conveyed object, the platform portion includes a first platform portion and a second platform portion, the first platform portion and the second platform portion are respectively disposed on a downstream side and an upstream side of the suction roller in a conveying direction, the first platform portion and the second platform portion are separated from each other, and an open portion exposing the suction roller is disposed in a region where the first platform portion and the second platform portion are separated in the conveying direction.

In an embodiment of the disclosure, the conveying device further includes: a roller component, conveying the conveyed object along the conveying direction. The platform portion is disposed at a position lower than an upper end of the roller component, and a void portion is disposed between the conveyed object and the platform portion in a normal direction of the platform portion.

In an embodiment of the disclosure, when looking forward facing the platform portion, the roller component is spaced apart from the platform portion in an axial direction of the suction roller and is disposed on two sides of the open portion in the axial direction of the suction roller.

In an embodiment of the disclosure, a width of the roller component in the conveying direction is greater than or equal to a width of the platform portion in the conveying direction.

In an embodiment of the disclosure, a distance of the void portion in the normal direction of the platform portion is less than a distance of the open portion in the conveying direction.

In an embodiment of the disclosure, the cap component has a front wall portion, a back wall portion, and a side wall portion extending from the platform portion toward the suction roller, the front wall portion is disposed at a position on the downstream side of the suction roller in the conveying direction, the back wall portion is disposed at a position on the upstream side of the suction roller in the conveying direction, and the side wall portion is disposed at a position covering end portions on two sides of an axial direction of the suction roller.

In an embodiment of the disclosure, the cap component includes: a peripheral portion, disposed at an outer periphery of the platform portion; and a recessed portion, extending from the peripheral portion toward a center of the cap component and recessed toward the open portion.

In an embodiment of the disclosure, the conveying device includes multiple conveying units, each of the conveying units includes the cap component, the suction roller, and the roller component, and the conveying units are disposed in parallel along an axial direction of the suction roller.

Based on the above, the conveying device forms a negative pressure region through configuring the cap component having the platform portion between the suction roller and the conveyed object, and exposing the suction roller through the open portion disposed between the first platform portion and the second platform portion. Thus, even if the conveying device uses the suction roller, the conveyed object can be held and conveyed without bending the conveyed object while having sufficient adsorption force.

In order for the features and advantages of the disclosure to be more comprehensible, the following specific embodiments are described in detail in conjunction with the drawings.

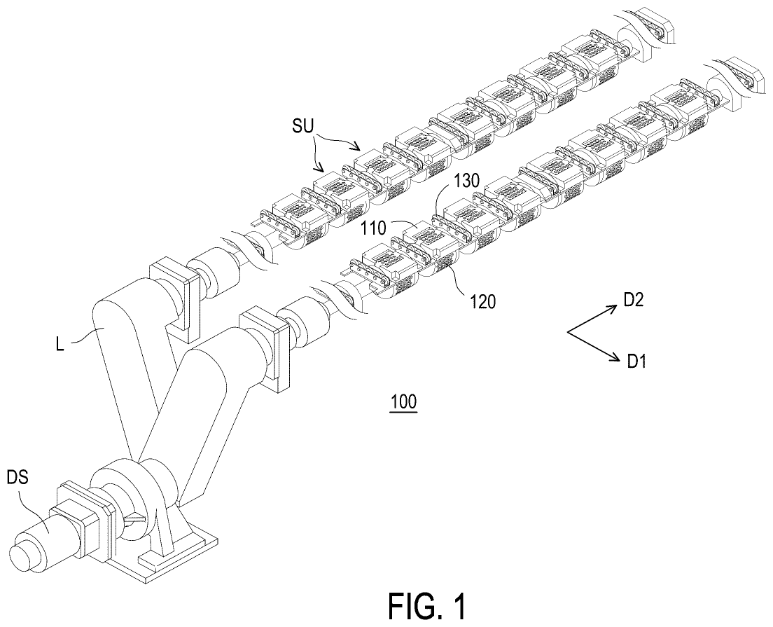

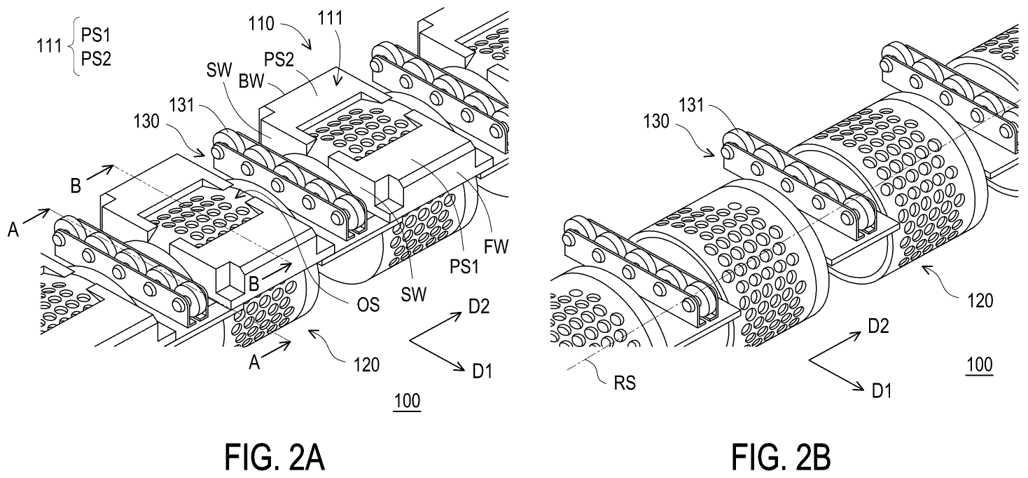

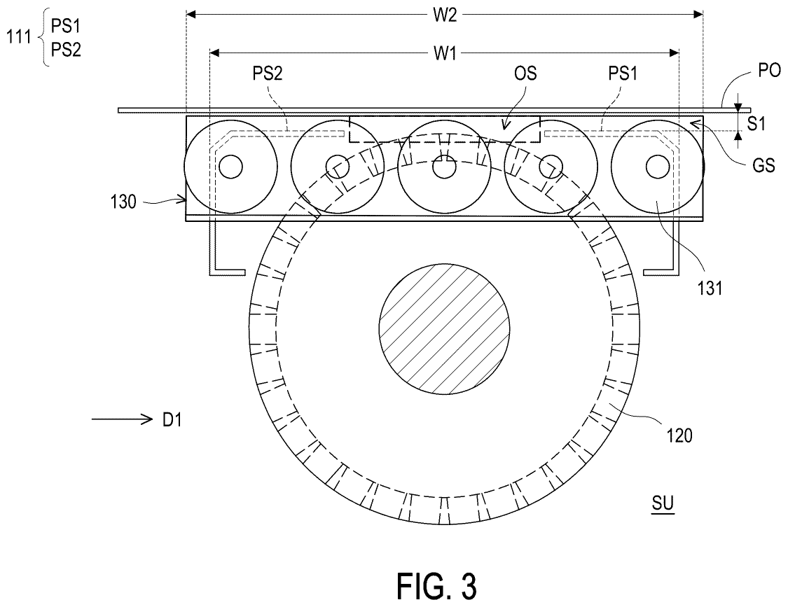

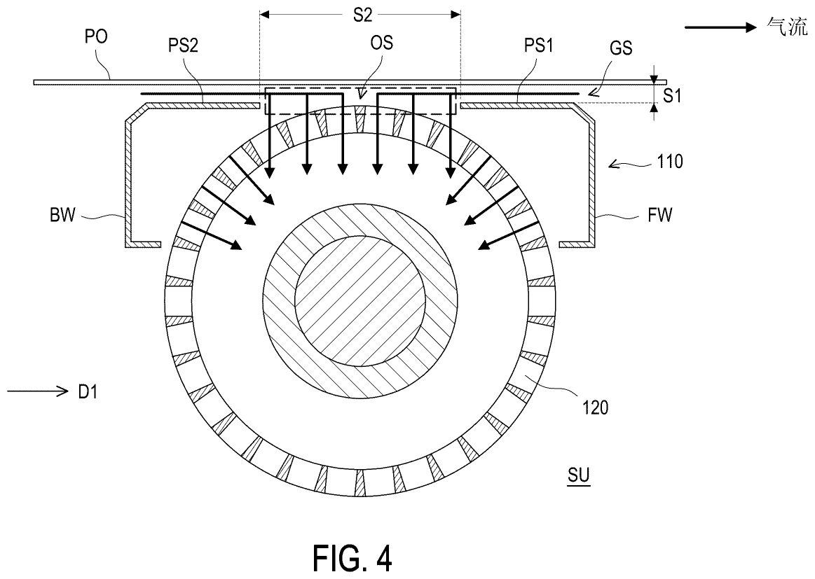

FIG. 1 is a schematic structural diagram of a conveying device according to an embodiment of the disclosure. FIG. 2A is a schematic partially enlarged diagram of a conveying unit shown in FIG. 1. FIG. 2B is a schematic diagram of the conveying unit shown in FIG. 1 after a cap component is removed. FIG. 3 is a schematic cross-sectional structural diagram of the conveying unit of FIG. 2A along a section line A-A. FIG. 4 is a schematic cross-sectional structural diagram of the conveying unit of FIG. 2A along a section line B-B. The specific structure of a conveying device 100 will be described below with reference to FIG. 1 to FIG. 4.

Please refer to FIG. 1 to FIG. 4. In the embodiment, the conveying device 100 includes multiple conveying units SU. Each conveying unit SU includes a cap component 110, a suction roller 120, and a roller component 130. The suction roller 120 is configured to generate negative pressure to adsorb a conveyed object PO. In the embodiment, the conveyed object PO is, for example, a flat plate, and more specifically, a metal plate material commonly used in the automobile manufacturing industry. Specifically, as shown in FIG. 1 and FIG. 2B, in the embodiment, the suction rollers 120 of the conveying units SU are coaxial and share the same rotating shaft RS. Furthermore, in the embodiment, the suction roller 120 is cylindrical, and the conveying units SU are disposed in parallel along an axial direction D2 of the rotating shaft RS of the suction roller 120 to form a long stick shape. In addition, as shown in FIG. 1, in the embodiment, the axial direction D2 of the rotating shaft RS of the suction roller 120 is orthogonal to a conveying direction D1 of the conveying device 100 conveying the conveyed object PO.

Specifically, as shown in FIG. 1, in the embodiment, in order to simplify the structure, the conveying device 100 only fixes one end of the rotating shaft RS of the suction roller 120 onto a drive shaft DS using a cantilever L, and inserts a fixed negative pressure chamber into the inside of the suction roller 120 from an unsupported end of the rotating shaft RS of the suction roller 120. As such, since the negative pressure chamber is not a structure floating inside the movable suction roller 120, the drive shaft DS of the conveying device 100 may be simply supported by a single-stage bearing.

On the other hand, as shown in FIG. 1 to FIG. 4, in the embodiment, the cap component 110 is disposed between the suction roller 120 and the conveyed object PO. Moreover, as shown in FIG. 2A and FIG. 4, the cap component 110 includes a platform portion 111 and a front wall portion FW, a back wall portion BW, and a side wall portion SW extending from the platform portion 111 toward the suction roller 120. As shown in FIG. 2A and FIG. 4, in the embodiment, the platform portion 111 faces the conveyed object PO and includes a first platform portion PS1 and a second platform portion PS2. The first platform portion PS1 and the second platform portion PS2 are respectively disposed on a downstream side and an upstream side of the suction roller 120 in the conveying direction D1, the first platform portion PS1 and the second platform portion PS2 are separated from each other, and an open portion OS exposing the suction roller 120 is disposed in a region where the first platform portion PS1 and the second platform portion PS2 are separated in the conveying direction D1.

In this way, the conveying device 100 may enable the suction roller 120 to generate negative pressure through the configuration of the negative pressure chamber, so that the suction roller 120 may adsorb the conveyed object PO, and the conveying device 100 forms a planar negative pressure region through configuring the cap component 110 having the platform portion 111 between the suction roller 120 and the conveyed object PO, and exposing the suction roller 120 through the open portion OS disposed between the first platform portion PS1 and the second platform portion PS2. Thus, even if the conveying device 100 uses the suction roller 120, the conveyed object PO can be held and conveyed without bending the conveyed object PO while having sufficient adsorption force.

More specifically, compared with the structure in the prior art that adsorbs the flat conveyed object PO onto a curved surface of the suction roller 120, which can only bring the flat conveyed object PO into linear contact with a region where a negative pressure space is generated, the conveying device 100 can separate a space between the curved surface of the suction roller 120 and the conveyed object PO through configuring the platform portion 111 of the cap component 110, which can further create a space with negative pressure within a large range, and form the planar negative pressure region within a range where the cap component 110 faces the conveyed object PO. Furthermore, if the open portion OS is widened as much as possible inside the cap component 110, a suction wind speed in the negative pressure region may be increased in the case where no conveyed object PO is disposed, thereby generating sufficient negative pressure.

On the other hand, as shown in FIG. 2A and FIG. 4, in the embodiment, the front wall portion FW of the cap component 110 is disposed at a position on the downstream side of the suction roller 120 in the conveying direction D1, the back wall portion BW is disposed at a position on the upstream side of the suction roller 120 in the conveying direction D1, and the side wall portion SW is disposed at a position covering end portions on two sides of the axial direction D2 of the suction roller 120. More specifically, the front wall portion FW of the cap component 110 extends from the side of the most downstream side of the first platform portion PS1 in the conveying direction D1 toward the suction roller 120, the back wall portion BW of the cap component 110 extends from the side of the most upstream side of the second platform portion PS2 in the conveying direction D1 toward the suction roller 120, and the side wall portion SW of the cap component 110 is formed by respectively extending from the sides of the first platform portion PS1 and the second platform portion PS2 parallel to the conveying direction D1 toward the suction roller 120. In this way, through the configurations of the front wall portion FW, the back wall portion BW, and the side wall portion SW of the cap component 110, the cap component 110 is formed into a structure having a wall shape on a side surface, which may cover the suction roller 120 on the side surface and may store the negative pressure generated by the suction roller 120 inside the cap component 110 to stably supply the negative pressure to the negative pressure region where the open portion OS is located.

On the other hand, as shown in FIG. 1 to FIG. 4, in the embodiment, the roller component 130 includes multiple rolling rollers 131 and holds and conveys the conveyed object PO along the conveying direction D1. Furthermore, as shown in FIG. 3, the platform portion 111 is disposed at a position lower than an upper end of the roller component 130. Furthermore, when looking forward facing the platform portion 111, the roller component 130 is spaced apart from the platform portion 111 in the axial direction D2 of the suction roller 120 and is disposed on two sides of the open portion OS in the axial direction D2 of the suction roller 120. Moreover, as shown in FIG. 4, through configuring the platform portion 111 at the position lower than the upper end of the roller component 130, a space separating the conveyed object PO and the cap component 110 may be formed between the conveyed object PO and the platform portion 111, that is, a void portion GS may be disposed between the conveyed object PO and the platform portion 111 in a normal direction of the platform portion 111.

In this way, through configuring the roller components 130 on two sides of the platform portion 111 and the open portion OS in the axial direction D2 of the suction roller 120, the range of the void portion GS between the platform portion 111 of the cap component 110 and a supporting height of the rolling roller 131 may be controlled, and the void portion GS is provided with a minimum gap such that the conveyed object PO does not contact the curved surface of the rotating suction roller 120 and the platform portion 111 of the cap component 110, and the negative pressure may be maintained, so that the height of the void portion GS is controlled within the minimum height range. Thus, the suction roller 120 may rotate smoothly while maintaining the minimum gap and keeping the conveyed object PO parallel, and the conveyed object PO may be prevented from contacting the platform portion 111, thereby preventing the conveyed object PO from being damaged due to contact with the cap component 110 or the suction roller 120 of the conveying device 100. Furthermore, when the suction roller 120 generates the negative pressure, air within the void portion GS may also be sucked from the negative pressure region where the open portion OS is located, thereby generating the negative pressure in the entire void portion GS.

On the other hand, as shown in FIG. 4, in the embodiment, a distance S1 of the void portion GS in the normal direction of the platform portion 111 is less than a distance S2 of the open portion OS in the conveying direction D1. In this way, a flow cross-sectional area for gas flow in the void portion GS is significantly less than a flow cross-sectional area for gas flow in the negative pressure region where the open portion OS is located. Gas flow velocity in the void portion GS increases due to the Venturi effect, so the negative pressure may also be generated in the void portion GS. The so-called Venturi effect is specifically that when gas or liquid flows in a Venturi tube, due to the continuity equation of a fluid, the velocity of the gas or the liquid increases due to changes in the flow cross-sectional area. Moreover, based on the Bernoulli's theorem, the entire flow must undergo a pipe shrinkage process at the same time, so pressure also decreases at the same time, thereby generating pressure differences at different places of the cross-sectional area. Such pressure differences provide an external suction to the fluid, thereby generating the negative pressure. In the embodiment, since the flow cross-sectional area for the gas flow in the void portion GS is significantly less than the flow cross-sectional area for the gas flow in the negative pressure region where the open portion OS is located, the gas flow velocity in the void portion GS is greater than the gas flow velocity in the negative pressure region where the open portion OS is located, and gas pressure is relatively reduced, thereby generating a region with a greater negative pressure in the void portion GS to more reliably adsorb the conveyed object PO.

In addition, as shown in FIG. 3, in the embodiment, the conveying device 100 is correspondingly provided with a region range of the roller component 130 in a region where the platform portion 111 is disposed at least in the conveying direction D1, that is, a width W1 of the roller component 130 in the conveying direction D1 is greater than or equal to a width W2 of the platform portion 111 in the conveying direction D1. In this way, in the conveying direction D1, through correspondingly configuring the region range of the roller component 130 in the region where the platform portion 111 is disposed, even if the conveyed object PO is deformed by the negative pressure generated by the open portion OS, that is, the conveyed object PO is attracted by the negative pressure and deformed downward into a concave shape, contact between the conveyed object PO and the platform portion 111 may still be prevented. For instance, as a comparative example, if the width W1 of the roller component 130 in the conveying direction D1 is less than the width W2 of the platform portion 111 in the conveying direction D1, when the conveyed object PO is deformed downward into a concave shape, the conveyed object PO may contact an edge of the platform portion 111 (that is, a corner portion of the platform portion 111) and may be deformed, thereby failing to stably hold and convey the conveyed object PO. In contrast, through the configuration of the width W1 of the roller component 130 of the conveying device 100 in the conveying direction D1 being greater than or equal to the width W2 of the platform portion 111 in the conveying direction D1, even if the conveyed object PO is deformed by the negative pressure generated by the open portion OS, that is, the conveyed object PO is attracted by the negative pressure and deformed downward into a concave shape, contact between the conveyed object PO and the platform portion 111 may still be prevented to stably hold and convey the conveyed object PO.

On the other hand, in the embodiment, since the conveying device 100 includes multiple conveying units SU, and the number of the conveying units SU may be increased according to the width size of the conveyed object PO, more conveying units SU may be easily added to expand the range of the conveying device 100 holding and conveying the conveyed object PO, so as to eliminate size limitation on the conveyed object PO. Furthermore, the conveying device 100 may also manage the ability to generate the negative pressure for each conveying unit SU. Therefore, a stable negative pressure can be generated regardless of the size of the conveying device 100.

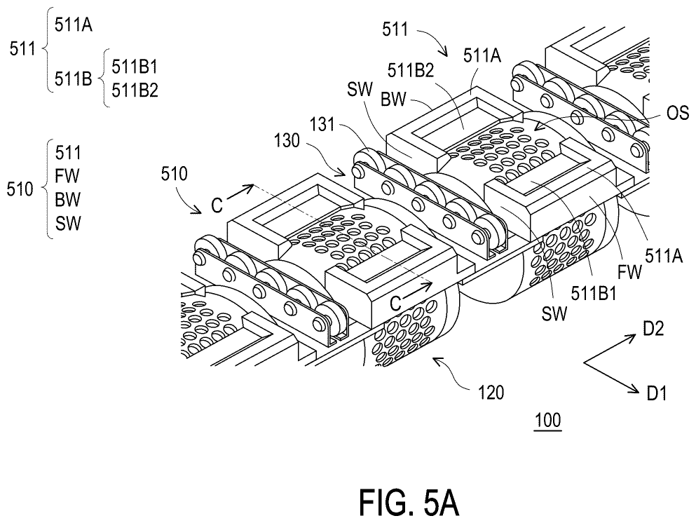

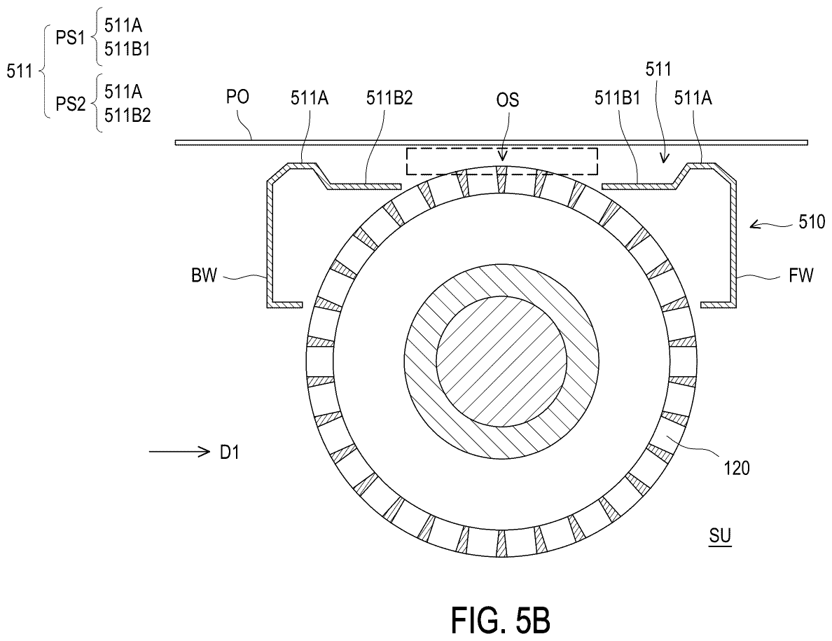

It should be noted that in the embodiment, the platform portion 111 of the cap component 110 may have different structures as long as the planar negative pressure region may be formed within the range of the cap component 110 facing the conveyed object PO. The following will provide further explanation in conjunction with FIG. 5A and FIG. 5B.

FIG. 5A is a schematic partially enlarged diagram of another conveying unit SU shown in FIG. 1. FIG. 5B is a schematic cross-sectional structural diagram of the conveying unit SU of FIG. 5A along a section line C-C. Please refer to FIG. 5A and FIG. 5B. In the embodiment, a platform portion 511 of a cap component 510 is similar to the platform portion 111 of the cap component 110 of FIG. 2A, and the difference between the two is as follows. In the embodiment, the platform portion 511 of the cap component 510 includes a peripheral portion 511A and a recessed portion 511B, wherein the peripheral portion 511A is disposed at an outer periphery of the platform portion 511, and the recessed portion 511B extends from the peripheral portion 511A toward the center of the cap component 510 and is recessed toward the open portion OS.

More specifically, as shown in FIG. 5A, the peripheral portion 511A of the cap component 510 is formed by a side edge of the first platform portion PS1 on the most downstream side in the conveying direction D1 and a side edge of the first platform portion PS1 parallel to the conveying direction D1 and a side edge of the second platform portion PS2 on the most upstream side in the conveying direction D1 and a side edge of the second platform portion PS2 parallel to the conveying direction D1. Furthermore, the first platform portion PS1 includes a first recessed portion 511B1. The first recessed portion 511B1 extends from the side edge on the most downstream side in the conveying direction D1 and the side edge of the first platform portion PS1 parallel to the conveying direction D1 toward the open portion OS and is recessed toward the open portion OS. The second platform portion PS2 includes a second recessed portion 511B2. The second recessed portion 511B2 extends from the side edge on the most upstream side in the conveying direction D1 and the side edge of the second platform portion PS2 parallel to the conveying direction D1 toward the open portion OS and is recessed toward the open portion OS. A range of the recessed portion 511B of the cap component 510 refers to a range covered by the first recessed portion 511B1 of the first platform portion PS1 and the second recessed portion 511B2 of the second platform portion PS2.

In this way, the outer periphery of the platform portion 511 provides a structure for preventing the negative pressure from leaking toward the surrounding (that is, a structure with good sealing) through maintaining a close distance between the peripheral portion 511A and the conveyed object PO, and the negative pressure may also be stored in the recessed portion 511B outside the open portion OS through forming the configuration of the recessed portion 511B recessed from the peripheral portion 511A of the platform portion 511 toward the center. Therefore, the entire region of the recessed portion 511B outside the peripheral portion 511A of the platform portion 511 may generate the negative pressure, and the negative pressure region formed within the range of the cap component 510 facing the conveyed object PO may be expanded to a region outside the open portion OS, so that the conveyance of the conveyed object PO is more stable.

Furthermore, since the structure of the platform portion 511 of the cap component 510 is similar to the structure of the platform portion 111 of the cap component 110, similar effects and advantages as those of the platform portion 111 of the cap component 110 can be achieved, which will not be described in detail herein. Furthermore, when the conveying device 100 adopts the structure of the platform portion 511 of the cap component 510, the above effects and advantages can also be achieved, which will not be described in detail herein.

In summary, in the embodiments of the disclosure, the conveying device forms the negative pressure region through configuring the cap component having the platform portion between the suction roller and the conveyed object, and exposing the suction roller through the open portion disposed between the first platform portion and the second platform portion. Thus, even if the conveying device uses the suction roller, the conveyed object can be held and conveyed without bending the conveyed object while having sufficient adsorption force.

Furthermore, since the conveying device of the disclosure uses suction to attract and hold the conveyed object, the conveyed object may be conveyed even if the conveyed object is made of a non-magnetic material (for example, a material such as an aluminum or carbon fiber reinforced polymer (CFRP) resin material), which may be applied to production processes, manufacturing techniques, and equipment that help save energy.

Finally, it should be noted that the above embodiments are only configured to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. A conveying device, comprising:
a suction roller, configured to generate negative pressure to adsorb a conveyed object; and
a cap component, disposed between the suction roller and the conveyed object, wherein the cap component has a platform portion, the platform portion faces the conveyed object,
the platform portion comprises a first platform portion and a second platform portion, the first platform portion and the second platform portion are respectively disposed on a downstream side and an upstream side of the suction roller in a conveying direction, and the first platform portion and the second platform portion are separated from each other, and
an open portion exposing the suction roller is disposed in a region where the first platform portion and the second platform portion are separated in the conveying direction.

2. The conveying device according to claim 1, further comprising:
a roller component, conveying the conveyed object along the conveying direction, wherein
the platform portion is disposed at a position lower than an upper end of the roller component, and a void portion is disposed between the conveyed object and the platform portion in a normal direction of the platform portion.

3. The conveying device according to claim 2, wherein:
when looking forward facing the platform portion, the roller component is spaced apart from the platform portion in an axial direction of the suction roller and is disposed on two sides of the open portion in the axial direction of the suction roller.

4. The conveying device according to claim 3, wherein:
a width of the roller component in the conveying direction is greater than or equal to a width of the platform portion in the conveying direction.

5. The conveying device according to claim 2, wherein a distance of the void portion in the normal direction of the platform portion is less than a distance of the open portion in the conveying direction.

6. The conveying device according to claim 2, wherein:
the cap component has a front wall portion, a back wall portion, and a side wall portion extending from the platform portion toward the suction roller,
the front wall portion is disposed at a position on the downstream side of the suction roller in the conveying direction,
the back wall portion is disposed at a position on the upstream side of the suction roller in the conveying direction,
the side wall portion is disposed at a position covering end portions on two sides of an axial direction of the suction roller.

7. The conveying device according to claim 1, wherein:
the cap component comprises:
a peripheral portion, disposed at an outer periphery of the platform portion; and
a recessed portion, extending from the peripheral portion toward a center of the cap component and recessed toward the open portion.

8. The conveying device according to claim 2, wherein the conveying device comprises a plurality of conveying units, each of the conveying units comprises the cap component, the suction roller, and the roller component, and the conveying units are disposed in parallel along an axial direction of the suction roller.
